(19) United States
(12) Patent Application Publication
(10) Pub. No.: US 2025/0171034 A1
(43) Pub. Date: May 29, 2025

(54) CUSTOM ENVIRONMENT IN A VEHICLE

(71) Applicant: Toyota Motor Engineering & Manufacturing North America, Inc., Plano, TX (US)

(72) Inventors: Benjamin Piya Austin, Saline, MI (US); Rohit Gupta, Santa Clara, CA (US); William Patrick Garrett, Plymouth, MI (US); Rebecca L. Kirschweng, Bloomfield Hills, MI (US); Philip J. Babian, Canton, MI (US); Dianne O. Tykoski, Canton, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/522,935

(22) Filed: Nov. 29, 2023

(51) Int. Cl. B60W 50/00; B60W 40/08

(52) U.S. Cl. CPC B60W 50/0098; B60W 40/08; B60W 2050/0083; B60W 2540/22; B60W 2540/221; B60W 2540/229

(57) ABSTRACT

Systems, methods, and other embodiments described herein relate to improving auditory and visual outputs in a vehicle environment based on occupant preferences. In one embodiment, a method includes acquiring occupant data about an occupant in a vehicle. The method further includes processing the occupant data to determine an occupant preference indicating proclivities of the occupant in relation to the surrounding environment. Additionally, the method includes in response to determining that vehicle settings satisfy a change threshold that is based, at least in part, on a difference between the vehicle settings and the occupant preference, adjusting the vehicle settings according to the occupant preference.

### TECHNICAL FIELD

The subject matter described herein relates, in general, to improving an environment of a vehicle, and, more particularly, to creating a custom environment for occupants in a vehicle.

### BACKGROUND

Vehicle cabin environments are designed in neutral manners with opportunities for occupants to adjust visual, audio, haptic, and comfort outputs manually. For example, occupants can manually adjust the brightness of vehicle displays, ambient lighting brightness and colors, speaker volumes, haptic notification settings, vehicle temperatures, heated seat settings, and so on. However, as occupants experience varying cognitive loads, driving environments, and road conditions, it may be desirable to adjust the visual, audio, haptic, and comfort outputs. As an example, a driver may prefer quieter music when experiencing a high cognitive load so that the driver can focus on the road. Further, any time a new group of occupants enters the vehicle, the group will likely prefer new audio and visual outputs. As an example, where the occupants consist of children, the occupants may prefer to hear loud children's music and see colorful ambient lighting. On the other hand, where the occupants are adults, they may prefer a quieter environment with more neutral lighting. Additionally, where the occupants include individuals with sensory processing disorders may benefit from visuals/noises that facilitate feelings of relaxation. Requiring occupants to manually adjust vehicle outputs when a new group enters the vehicle and/or when environmental conditions change can add unnecessary travel time, cause the driver to become distracted, invoke feelings of anger or annoyance in the occupants, and/or cause other undesirable conditions.

### SUMMARY

In one embodiment, example systems and methods relate to a manner of creating a custom audio and visual environment for vehicle occupants. As previously discussed, current methods of providing a customized environment for vehicle occupants involve manual adjustments on behalf of the vehicle occupants. Manually adjusting environmental settings can lead to unnecessary distractions, increased travel time, annoyance among passengers, and other undesirable conditions.

Therefore, in one embodiment, a system that improves creating a custom environment in a vehicle cabin is disclosed. The system is generally configured to acquire information about occupants in a vehicle in order to determine an auditory, visual, haptic, and comfort environment that would be pleasing to the occupants. The information may be acquired from a profile associated with the occupant. The profile may be developed by devices of the occupant passively and actively collecting data regarding audio and visual preferences of the occupant. For example, devices, such as a smartphone, smart TV, smart home system, smart watch, electronic cognitive aid, voice activation device, voice assistant device, voice assistant program of a vehicle, etc., may collect information about how the occupant reacts to different audio, visual, haptic, and comfort outputs encountered throughout the day. Audio, visual, haptic, and comfort preferences in the profile can include audio, visual, haptic, and comfort outputs that invoke happiness or other positive feelings in the occupant. When the current vehicle settings do not coincide with the preferences stored in the profile, the system adjusts the vehicle settings by outputting visuals, audio, haptics, and comfort settings that are likely to invoke positivity in the occupant and that maximize occupant satisfaction.

The occupant preferences stored in the profile can also include preferences that correspond to differing cognitive states of the occupant. For example, when the occupant is focused on performing a complicated driving maneuver, the occupant may prefer vehicle settings that are neutral and quiet to avoid being distracted. As such, the vehicle settings can be adjusted according to the cognitive state of the occupant. Further, where the occupant is a driver of the vehicle, it is important that the vehicle settings allow the driver to react quickly in situations that require driver attention. Accordingly, the information in the driver profile may include audio, visual, and haptic outputs that have previously grasped the driver's attention quickly. Therefore, when the driver is confronted with a critical driving condition, such as when a safety warning needs to be issued, the vehicle settings can be adjusted to output audio, visuals, and haptics that will invoke a fast reaction time in the driver.

Moreover, where multiple occupants are present in the vehicle, the system may acquire and process the preference information about all of the occupants to determine a group preference of the occupants. The group preference can correspond to vehicle settings that would invoke positivity and maximize satisfaction among all of the occupants. Accordingly, the vehicle settings can adjust to please the occupants as a whole. In this way, the system adjusts and customizes vehicle settings to satisfy occupants in the vehicle.

In one embodiment, a system is disclosed. The system includes one or more processors and a memory communicably coupled to the one or more processors. The memory storing instructions that, when executed by the one or more processors, cause the one or more processors to acquire occupant data about an occupant in a vehicle. The instructions further include instructions to process the occupant data to determine an occupant preference indicating proclivities of the occupant in relation to the surrounding environment. Additionally, the instructions include instructions to responsive to determining that vehicle settings satisfy a change threshold that is based, at least in part, on a difference between the vehicle settings and the occupant preference, adjust the vehicle settings according to the occupant preference.

In one embodiment, a non-transitory computer-readable medium and including instructions that when executed by one or more processors cause the one or more processors to perform one or more functions is disclosed. The instructions include instructions to acquire occupant data about an occupant in a vehicle. The instructions further include instructions to process the occupant data to determine an occupant preference indicating proclivities of the occupant in relation to the surrounding environment. Additionally, the instructions include instructions to responsive to determining that vehicle settings satisfy a change threshold that is based, at least in part, on a difference between the vehicle settings and the occupant preference, adjust the vehicle settings according to the occupant preference.

In one embodiment, a method is disclosed. In one embodiment, the method includes acquiring occupant data about an occupant in a vehicle. The method further includes processing the occupant data to determine an occupant preference indicating proclivities of the occupant in relation to the surrounding environment. Additionally, the method includes in response to determining that vehicle settings satisfy a change threshold that is based, at least in part, on a difference between the vehicle settings and the occupant preference, adjusting the vehicle settings according to the occupant preference.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of an immersion system that is associated with providing a custom vehicle environment for occupants.

FIG. 3 illustrates one embodiment of the immersion system of FIG. 2 in a cloud-computing environment.

FIG. 4 illustrates one embodiment of a method that is associated with determining an occupant preference for visual, audio, haptic, and comfort settings.

FIG. 5 illustrates one embodiment of a method that is associated with improving an audio, visual, haptic, and/or comfort environment of a vehicle according to occupant preferences.

FIG. 6 illustrates a sequence associated with improving a vehicle environment of an occupant.

### DETAILED DESCRIPTION

Systems, methods, and other embodiments associated with improving a vehicle environment using occupant preferences are disclosed herein. As previously discussed, vehicle cabins are preconfigured to output audio, visuals, haptics, and comfort settings that are not preferred by all occupants. To customize a vehicle cabin environment, occupants can manually adjust vehicle settings. However, manually adjusting vehicle settings can lead to unnecessary distractions, increased travel time, annoyance among passengers, and other undesirable conditions.

Therefore, in one embodiment, a system that improves creating an audio and visual environment in a vehicle cabin is disclosed. The system is generally configured to acquire information about occupants in a vehicle in order to determine an environment that is preferred by the occupants. The system acquires the information from a profile associated with the occupant. The system develops the profile by devices of the occupant passively and actively collecting data regarding audio and visual preferences of the occupant. The system determines the preferences of the occupants by identifying physiological reactions (e.g., changes in heart rate, body movement, eye movement, changes in facial features, galvanic skin response, etc.) of the occupant corresponding to various audio, visual, haptic, and comfort outputs. The physiological reactions are indicative of a mental state of the occupant, where the mental state can include mental states associated with the occupant feeling positive, happy, stressed, distracted, focused, etc. Further, in one arrangement, when the devices collect the physiological reactions of the occupant, the devices may prompt the occupant to confirm a mental state that corresponds to a physiological reaction of the occupant to confirm that the occupant actually feels happy, relaxed, stressed, etc., in response to different audio/visual outputs.

In any case, the recordation of physiological reactions can occur both when the occupant is in the vehicle and when the occupant is in an environment external to the vehicle (e.g., when the occupant is at home, at work, outside, etc.). Passive data collection includes collecting information associated with a physiological reaction of the occupant to audio/visual outputs encountered throughout the day. For example, devices, such as a smartphone, smart TV, smart home system, smart watch, electronic cognitive aid, voice activation device, voice assistant device, voice assistant program of a vehicle, etc. may passively collect information about how the occupant reacts to different audio, visual, haptic, and comfort outputs that are naturally presented to the occupant. In addition to passive data collection, the occupant information is collected using active data collection methods. To actively collect occupant information, devices of the occupant can intentionally present the occupant with audio/visual/haptic/comfort outputs to record a physiological reaction of the occupant associated with the presented audio/visual/haptic/comfort outputs. As an example, devices of the occupant may output visuals with different colors and luminescence according to the ambient lighting of the vehicle, audio with different frequencies, tones, and volumes, haptics with different vibration frequencies, and comfort settings that correspond to different temperatures, air flow rates, and scents to record the reactions of the occupant to the various outputs. The devices of the occupant record the physiological reactions of the occupant and store the acquired reactions in the occupant profile.

In addition to determining the preferences based on physiological reactions of the occupant, the system may further determine the preferences based on information associated with choices/interactions of the occupant with devices. The system may determine the preference for a vehicle voice assistance (VA) voice based on data received from the occupant interacting with a VA device at home. For example, if the occupant often asks a home VA device to repeat itself when the voice output is an American man, the system determines that the occupant likely does not understand the outputted voice and that the preference of the occupant is, therefore, not that of an American man. On the other hand, if the occupant chooses the VA voice of the VA home device to be a British woman and/or the occupant rarely or never asks the VA voice corresponding to a British woman to repeat itself, for example, the system determines that a British woman voice is preferred by the occupant.

Audio, visual, haptic, and comfort preferences in the profile can include audio, visual, haptic, and comfort outputs that invoke physiological reactions associated with happiness or other positive feelings in the occupant. Further, preferences may include preferences that correspond to choices/interactions of the occupant with devices. Additionally, the profile can include audio, visual, haptic, and comfort outputs that invoke stress or a distracted mental state in the occupant. When the current vehicle settings do not coincide with the preferences stored in the profile (i.e., when the settings are associated with audio/visual/haptic/comfort outputs that cause stress or distraction in the occupant and/or when the settings do not coincide with choices/interactions of the occupant), the system adjusts the vehicle settings by outputting visuals, audio, haptics, and comfort settings that are likely to invoke positivity in the occupant and that maximize occupant satisfaction.

The occupant preferences stored in the profile can also include preferences that correspond to differing cognitive states of the occupant. To determine occupant preferences during differing cognitive states, the system controls devices of the occupant to record the cognitive state of the occupant when collecting the physiological reaction data. The system can determine the cognitive state of the occupant by determining the current ability of the occupant to focus when the physiological reactions are acquired. For example, the cognitive state can include a state of the occupant while the occupant is experiencing varying degrees of cognitive load. As an example, when the occupant is focused on performing a complicated driving maneuver (i.e., a task that involves a high cognitive load), the occupant may prefer vehicle settings that are neutral and quiet to avoid being distracted. As such, the system adjusts the vehicle settings according to the cognitive state of the passenger.

Further, the occupant preferences stored in the profile can include preferences that correspond to physiological reactions that are associated with occupant reactions to audio/visual/haptic/comfort outputs. For example, where the occupant is the driver of the vehicle, it is important that the vehicle settings allow the driver to react quickly in situations that require driver attention. Accordingly, the information in the driver profile may include audio, visual, and haptic outputs that have previously grasped the driver's attention quickly. Indications that the attention of an occupant has been grasped quickly by audio/visuals/haptics can include various physiological reactions, such as increased heart rate in the presence of the audio/visuals/haptics, changes in eye/head movements towards an audio/visual/haptic output, increased skin arousal or brain activity in the presence of audio/visuals/haptics, etc. In any case, when the system determines that the attention of the driver is needed, such as when a potential collision is likely, the vehicle settings can be adjusted to output audio, visuals, and haptics that will invoke a fast reaction time in the driver.

Moreover, where multiple occupants are present in the vehicle, the system may acquire and process the preference information about all of the occupants to determine a group preference of the occupants. The group preference can correspond to vehicle settings that invoke a physiological reaction indicative of mental states among all of the occupants, such as mental states that correspond to happiness and/or relaxation. Accordingly, the system can adjust the vehicle settings to please the occupants as a whole by adjusting the settings to invoke a collective physiological reaction associated with feelings of positivity. Instead of adjusting the vehicle settings to satisfy the occupants as a whole, where the occupants include a driver and one or more additional passengers, the system can adjust the vehicle settings to prioritize settings that allow the driver to focus on the task of driving the vehicle over settings that the passengers may prefer. In this way, the system can prioritize safety of the passengers over comfort. Additionally, the system can adjust the vehicle settings in different regions of the vehicle depending on where the occupants are seated. For example, the driver may prefer a yellow ambient light while a passenger in a rear seat of the vehicle prefers a green ambient light. As such, the system adjusts the individual regions of the vehicle according to individual occupant preferences. In this way, the system improves an occupant experience within a vehicle by customizing vehicle settings according to preferences of the occupant.

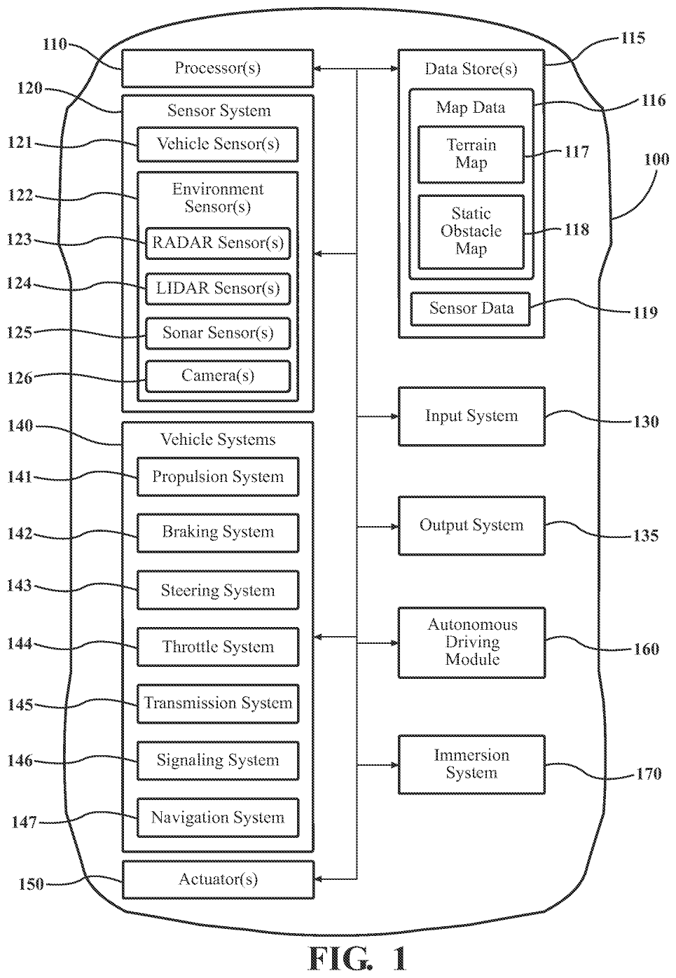

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, the vehicle 100 may be any form of motorized transport that, for example, includes a customizable interior environment for occupants of the vehicle 100. As used herein, an “occupant” is a person, such as a driver, passenger, or animal that can travel in the vehicle 100.

The vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within a vehicle while further components of the system are implemented within a cloud-computing environment or other system that is remote from the vehicle 100.

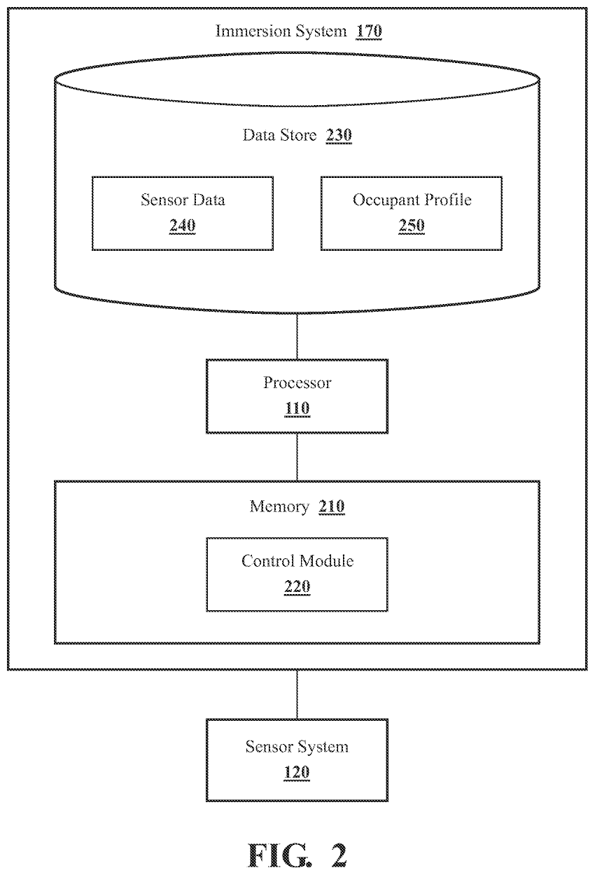

Some of the possible elements of the vehicle 100 are shown in FIG. 1 and will be described along with subsequent figures. However, a description of many of the elements in FIG. 1 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes an immersion system 170 that is implemented to perform methods and other functions as disclosed herein relating to improving audio and visual vehicle settings output to occupants. As will be discussed in greater detail subsequently, the immersion system 170, in various embodiments, is implemented partially within the vehicle 100, and as a cloud-based service. For example, in one approach, functionality associated with at least one module of the immersion system 170 is implemented within the vehicle 100 while further functionality is implemented within a cloud-based computing system.

With reference to FIG. 2, one embodiment of the immersion system 170 of FIG. 1 is further illustrated. The immersion system 170 is shown as including a processor 110 from the vehicle 100 of FIG. 1. Accordingly, the processor 110 may be a part of the immersion system 170, the immersion system 170 may include a separate processor from the processor 110 of the vehicle 100, or the immersion system 170 may access the processor 110 through a data bus or another communication path. In one embodiment, the immersion system 170 includes a memory 210 that stores a control module 220. The memory 210 is a random-access memory (RAM), read-only memory (ROM), a hard-disk drive, a flash memory, or other suitable memory for storing the control module 220. The control module 220 is, for example, computer-readable instructions that when executed by the processor 110 cause the processor 110 to perform the various functions disclosed herein.

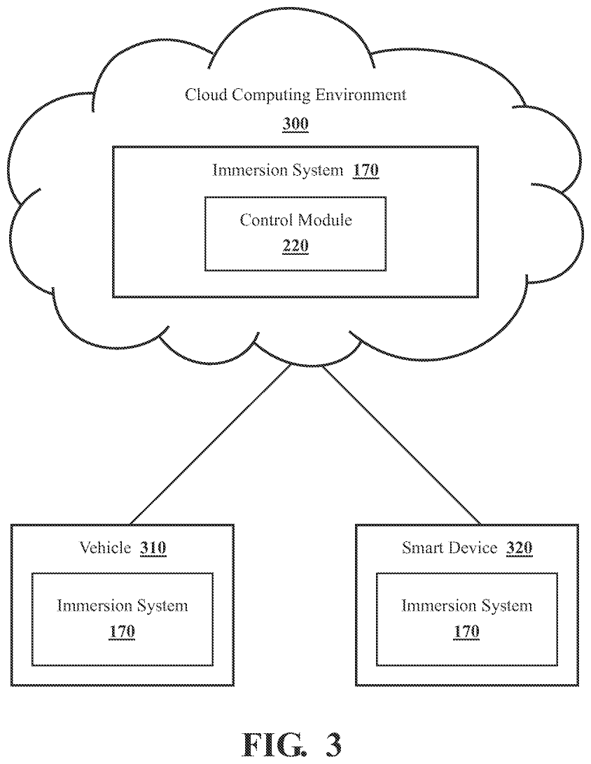

The immersion system 170 as illustrated in FIG. 2 is generally an abstracted form of the immersion system 170 as may be implemented between the vehicle 100 and a cloud-computing environment. FIG. 3 illustrates one example of a cloud-computing environment 300 that may be implemented along with the immersion system 170. As illustrated in FIG. 3, the immersion system 170 is embodied at least in part within the cloud-computing environment 300 and also within a reporting vehicle 310 and reporting smart device 320. That is, the cloud-computing environment 300, the vehicle 310, and the smart device 320 each include the control module 220 or at least a portion thereof. Thus, the control module 220 is generally implemented within both aspects of the immersion system 170 in order to provide for handling of the electronic data that includes occupant preferences.

Moreover, the vehicle 310 and the smart device 320 generally represent reporting devices that are equipped with sensors to identify physiological reactions and preferences of vehicle occupants. That is, the vehicle 310 is, for example, a vehicle similar to the vehicle 100. The noted vehicle may be autonomous, semi-autonomous, equipped with advanced driving assistance systems (ADAS), or another arrangement that generally includes sensors capable of acquiring occupant physiological reactions. The noted smart device may be a smart television (TV), a smart home system, a smart security system, a wearable device (e.g., a smart watch), a mobile phone, electronic cognitive aid, voice activation device, voice assistant device, voice assistant program of a vehicle, or other device that generally includes sensors for acquiring occupant physiological reactions. Additionally, while one vehicle and one smart device are illustrated, it should be appreciated that as a general matter the number of vehicles and smart devices are not limited but instead includes any number of vehicles/smart devices that are equipped in the noted manner and provide reports about the preferences for audio/visual settings of occupants.

With continued reference to FIG. 2, the control module 220 generally includes instructions that function to control the processor 110 to receive data inputs from one or more sensors of the vehicle 100. The inputs are, in one embodiment, physiological reactions of one or more occupants within the vehicle 100. Physiological reactions are responses to visual/audible/haptic/comfort stimuli encountered by the occupant, where the physiological reactions may be manifested as changes in the heart rate of the occupant, facial expressions of the occupant, skin arousal/skin conductivity of the occupant, brain activity of the occupant, eye/head movements of the occupant, etc. As provided for herein, the control module 220, in one embodiment, acquires sensor data 240 that includes at least camera images. In further arrangements, the control module 220 acquires the sensor data 240 from further sensors such as an electroencephalogram (EEG) sensor, a near infrared spectroscopy sensor (NIRS sensor), a galvanic skin response (GSR) sensor, a heart rate sensor, and other sensors as may be suitable for identifying physiological reactions of an occupant in the vehicle 100.

Additionally, the sensor data 240 can include data associated with a cognitive state of the occupant when the physiological reactions of the occupant are acquired. The cognitive state of the occupant is associated with the current ability of the occupant to focus, which may be discerned based on the cognitive load of the user when the physiological reactions are acquired. A high cognitive load is, for example, associated with the occupant engaging in multiple tasks, mentally exhaustive tasks, and so on. A low cognitive load is associated with the occupant engaging in a task that requires little to no effort or mental strain on behalf of the occupant. The sensor data 240 associated with the cognitive state of the occupant can include body movements, behavior, facial expressions, brain activity, and/or an environment of the occupant as indicated by image/video data, data associated with inputs received by devices of the occupant, data relating to brain activity of the occupant (e.g., EEG and NIRS measurements), and so on.

In one approach, the control module 220 acquires the sensor data 240 from one or more nearby devices wirelessly connected to and in an environment external to the vehicle 100 and/or by connecting to the cloud-computing environment 300. The sensor data 240 includes, for example, physiological reaction data associated with the occupant as indicated by camera images and/or video from cameras, heart rate sensors, electrocardiogram (ECG or EKG) devices, GSR sensors, EEG sensors, NIRS sensors, etc. The nearby devices may include a smartphone, wearable devices, smart TV, security system, smart home system (e.g., Google Nest®, Amazon Alexa®)) etc.

In addition to physiological reactions, the sensor data 240 includes, in at least one arrangement, data relating to choices/interactions of the occupant with nearby devices. For example, the sensor data 240 may include information acquired from the occupant indicative of visual/audio/haptic/comfort preferences of the occupant. Inputs may include inputs relating to audio/visuals/haptics/comfort settings that cause different mental states in the occupant, inputs relating to favorite audio/visual/haptic/comfort setting outputs of the occupant, and/or inputs relating to unfavorable audio/visual/haptic/comfort setting outputs of the occupant. Further, the occupant may generate inputs in response to prompts from the devices of the occupant. For example, a device may ask the occupant to describe the feeling the occupant has in relation to an audio/visual/haptic/comfort output. The sensor data 240 may also include voice data associated with the occupant interacting with a voice assistance (VA) device. As an example, the sensor data 240 may include information associated with the number of times the occupant asks a particular VA voice to repeat a question/statement. In addition to voice data, the sensor data 240 associated with interactions of the occupant may further include information associated with the volume and sound frequency of audio outputs chosen by the occupant, the brightness, color, and flash pattern of visual outputs chosen by the occupant, the vibration frequency and location on the body upon which the occupant chooses to receive haptic notification, and/or comfort setting choices, such as chosen temperatures, heated seat settings, scents, and so on.

The control module 220 can establish wireless connections by connecting directly to local devices and/or to the cloud-computing environment 300, which may acquire the sensor data 240 from the local devices. For example, the control module 220 may establish a wireless communication link with nearby devices using a handshake process (e.g., over a Wi-Fi® network or via Bluetooth®). Responsive to the control module 220 establishing a wireless communication link with local devices and/or the cloud-computing environment 300, the control module 220 acquires the sensor data 240 relating to the occupant. In this way, the control module 220 receives additional sensor data beyond what is acquired from the sensors 120 of the vehicle 100.

Accordingly, the control module 220, in one embodiment, controls the respective sensors to provide the data inputs in the form of the sensor data 240. Additionally, while the control module 220 is discussed as controlling the various sensors to provide the sensor data 240, in one or more embodiments, the control module 220 can employ other techniques to acquire the sensor data 240 that are either active or passive. For example, the control module 220 may passively sniff the sensor data 240 from a stream of electronic information provided by the various sensors to further components within the vehicle 100. Moreover, the control module 220 can undertake various approaches to fuse data from multiple sensors when providing the sensor data 240 and/or from sensor data acquired over a wireless communication link. Thus, the sensor data 240, in one embodiment, represents a combination of perceptions acquired from multiple sensors.

Moreover, in one embodiment, the immersion system 170 includes a data store 230. In one embodiment, the data store 230 is a database. The database is, in one embodiment, an electronic data structure stored in the memory 210 or another data store and that is configured with routines that can be executed by the processor 110 for analyzing stored data, providing stored data, organizing stored data, and so on. Thus, in one embodiment, the data store 230 stores data used by the control module 220 in executing various functions. In one embodiment, the data store 230 stores the sensor data 240, an occupant profile 250, and other information used by the control module 220 in performing the noted functions.

The occupant profile 250 includes, in one configuration, baseline physiological data associated with the occupant. The baseline physiological data may include a resting heart rate of the occupant, a baseline skin conductivity of the occupant when the occupant is in a relaxed/resting state, baseline brainwave activity/brain blood flow of the occupant during periods of rest/relaxation, a resting facial expression of the occupant, and baseline heart rate, skin conductivity, brain activity, and facial expressions of the occupant during various cognitive loads experienced by the occupant.

In one or more arrangements, the occupant profile 250 additionally stores an occupant preference indicating proclivities of the occupant in relation to a surrounding environment. The occupant preference includes, in one approach, audio, visual, haptic, and comfort vehicle setting preferences of the occupant. In one embodiment, the profile stores general preferences of the occupant and further stores preferences of the occupant that correspond to a plurality of cognitive states associated with the occupant. For example, the occupant profile 250 may include default preferential audio/visual/haptic/comfort outputs as well as preferred audio/visual/haptic/comfort outputs corresponding to the occupant having a high cognitive load, low cognitive load, average cognitive load, etc.

The control module 220, in one embodiment, is further configured to perform additional tasks beyond controlling the respective sensors to acquire and provide the sensor data 240. For example, the control module 220 includes instructions that cause the processor 110 to process the sensor data 240 to determine an occupant preference that includes an auditory preference, a visual preference, a haptic preference, and a comfort preference. In one arrangement, the control module 220 determines the occupant preference by determining vehicle settings that invoke physiological reactions in the occupant. Responsive to determining the preferences of the occupant, the control module 220, in one approach, records and stores the occupant preferences in the occupant profile 250. As previously discussed, the physiological reactions can include changes in heart rate of the occupant, changes in skin arousal/conductivity, changes in facial expressions, and/or changes in eye/head/body movements of the occupant. The physiological reactions are, in one embodiment, indicative of a mental state (e.g., a happy state, a sad state, an angry state, an attentive state, a distracted state, a stressed state, etc.) of the occupant. In one approach, the control module 220 determines a mental state associated with audio/visual/haptic/comfort setting outputs experienced by/output to the occupant by comparing a current physiological reaction of the occupant to the baseline physiological data that is stored in the occupant profile 250.

Acquired heart rate data can indicate a mental state of the user in relation to a visual/audible/haptic/comfort output. For example, a heart rate that is elevated compared to the resting heart rate of the occupant (e.g., elevated by a threshold amount, such as 10 beats per minute (bpm) or 10%) may indicate mental states associated with happiness or stress while a decreased heart rate (e.g., decreased by a threshold amount, such as 10 bpm or 10%) may indicate mental states associated with a relaxed mental state. As another example, the low frequency (LF) to high frequency (HF) ratio of heart rate variability (HRV) can indicate mental states of the occupant. If the LF/HF ratio of HRV is low (e.g., 20-30), then the occupant is likely in a calm or relaxed mental state. In contrast, when the LF/HF ratio of HRV is high (e.g., 30-40), then the occupant is likely stressed. Increased skin arousal/skin conductivity (e.g., an increase of 5%, 0.1 micro Siemens (μS), etc.) in comparison to the baseline skin arousal/skin conductivity of the occupant may indicate feelings of happiness, attentiveness, stress, etc., while decreased skin arousal/skin conductivity (e.g., a decrease of 5%, 0.1 micro Siemens (μS), etc.) may indicate relaxation and comfort.

Additionally, physical movements and expressions, as indicated by the sensor data 240, can inform the control module 220 of the mental state of the occupant. For example, eye/head/body movements can indicate a response time associated with the occupant experiencing audio/visual outputs. Further, changes in facial expressions, as indicated by camera/video data, can indicate the mental state of the occupant. In one approach, the control module 220 uses a machine learning algorithm embedded within the control module 220, such as a convolutional neural network (CNN), to perform feature recognition over the sensor data 240 associated with the physical movements and facial expressions of the occupant. Of course, in further aspects, the control module 220 may employ different machine learning algorithms or implements different approaches for performing the associated functions, which can include deep convolutional encoder-decoder architectures, or another suitable approach that identifies expressions and body movements represented in the image/video data. Whichever particular approach the control module 220 implements, the control module 220 provides an output identifying the body movements and facial expressions represented in the sensor data 240. In this way, the control module 220 identifies characteristics about the occupant, such as the mental state and response time of the occupant from the sensor data 240.

To confirm that a physiological reaction corresponds to a mental state of the occupant, in one approach, the control module 220, in one embodiment, controls a device to prompt the occupant to answer questions and/or to provide feedback regarding the mental state of the occupant. For example, the device may ask the occupant, “Can you confirm that X sound has made you feel stressed?” As another example, the device may prompt the occupant to rate or provide feedback about the determination of the mental state of the occupant.

In any case, the control module 220 correlates identified physiological reactions with occupant preferences. In one embodiment, the control module 220 determines that the preferences of the occupant correspond to physiological reactions indicative of happy and relaxed mental states. Further, in one approach, the control module 220 determines the occupant preferences according to differing cognitive states of the occupant when the physiological reactions are acquired. The control module 220 may determine the cognitive state of the occupant according to the brain activity of the occupant, which can be in the form of EEG or NIRS sensor data. For example, depending on which regions of the brain are emitting brain waves (i.e., based on the EEG data) or which regions of the brain are experiencing increased levels of blood flow (i.e., based on the NIRS data), the control module 220 determines whether the occupant is engaged in another mentally intensive task. For example, if the occupant is experiencing a high cognitive load (e.g., the occupant is multi-tasking, performing a mentally exhaustive task, etc.) when a physiological reaction associated with the occupant being happy is acquired, the control module 220 determines that the positive physiological reaction corresponds to an occupant preference when the occupant is experiencing a high cognitive load.

In one arrangement, the occupant preference corresponds to vehicle settings that invoke quick responses to safety critical information in the occupant. Quick responses are, in one approach, reactions of the occupant that correspond to the occupant directing focus/attention to an audible/visual/haptic stimulus within a threshold amount of time (e.g., within three seconds or less). Physiological reactions that indicate reaction times include eye/head movements of the occupant, changes in heart rate and HRV, changes in skin conductivity, changes in brain activity, and so on. The control module 220, in one embodiment, determines the occupant preference by determining physiological reactions that indicate fast reaction times (i.e., physiological reactions that correspond to the occupant directing attention towards a visual/audio/haptic output within the threshold amount of time) of the occupant when experiencing different visual/audio/haptic stimuli.

The control module 220, in one embodiment, determines the occupant preference by analyzing inputs of the occupant generated by interactions with devices of the occupant. In one embodiment, the control module 220 determines that the occupant preference corresponds to the manual inputs that indicate favorable audio/visual/haptic/comfort setting inputs of the occupant. In one approach, the control module 220 analyzes the interactions of the occupant with devices to determine the preferences of the occupant. The control module 220, in one configuration, determines that settings chosen by the occupant correspond to an occupant preference and/or settings that do not invoke the occupant to ask the device to repeat itself correspond to an occupant preference. For example, if an occupant always adjusts the lighting of a smart TV to be twenty lumens (lms), the control module 220 determines that the occupant preference corresponds to lighting at a brightness of 20 lms. As another example, if the occupant always chooses a British woman VA voice and/or the occupant never asks a British woman VA voice to repeat itself, the control module 220 determines that the occupant prefers a British woman VA voice. In the case of comfort settings, the control module 220, in one approach, determines that the occupant prefers a temperature setting of sixty-eight degrees because the occupant always adjusts the temperature in a room to be sixty-eight degrees, that the occupant prefers a vanilla scent because the occupant always chooses a smart home device to emit vanilla scents, and so on. As yet another example, if the occupant typically selects haptic notifications to be output at 100 Hz, the control module 220 determines that the occupant prefers haptic notifications at 100 Hz.

In addition to acquiring and processing the occupant data to determine an occupant preference, the control module 220, in one approach, determines whether vehicle settings satisfy a change threshold that is based, at least in part, on a difference between the vehicle settings and the occupant preference. In one embodiment, the control module 220 determines that the vehicle settings satisfy the change threshold when the vehicle settings cause a physiological reaction indicative of a stressed state and/or distracted mental state. Conversely, in one approach, the control module 220 determines that the vehicle settings do not satisfy the change threshold when the vehicle settings cause a physiological reaction indicative of a happy and/or relaxed mental state. In one approach, the control module 220 determines that the vehicle settings satisfy the change threshold when the vehicle settings do not correspond to an occupant preference that is based on the manual inputs and/or interactions of the occupant. For example, if the control module 220 determines that, based on interactions/inputs of the occupant, the occupant prefers blue ambient lighting, but the vehicle settings output red ambient lighting, then the vehicle settings satisfy the change threshold. As another example if the control module 220 determines that based on interactions/inputs of the occupant, the occupant prefers to hear a British woman VA voice but the VA voice of the vehicle 100 is currently an American man, the vehicle settings satisfy the change threshold.

Responsive to determining that vehicle settings satisfy the change threshold, the control module 220, in one embodiment, adjusts the vehicle settings according to the occupant preference. For example, the control module 220 adjusts the vehicle settings by adjusting the auditory, visual, haptic, and comfort settings of the vehicle 100 to match the auditory, visual, haptic, and comfort preferences of the occupant. In this way, the immersion system 170 improves a vehicle environment according to occupant preferences.

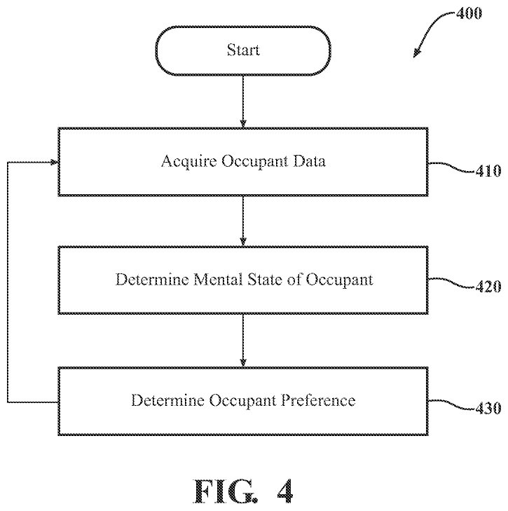

Additional aspects of providing a customized vehicle environment for occupants of a vehicle will be discussed in relation to FIG. 4. FIG. 4 illustrates a flowchart of a method 400 that is associated with determining an occupant preference for visual, audio, haptic, and/or comfort settings of a vehicle. Method 400 will be discussed from the perspective of the immersion system 170 of FIGS. 1, and 2. While method 400 is discussed in combination with the immersion system 170, it should be appreciated that the method 400 is not limited to being implemented within the immersion system 170 but is instead one example of a system that may implement the method 400.

At 410, the control module 220 acquires occupant data about at least one occupant in the vehicle 100. In one approach, the control module 220 acquires the occupant data by controlling the sensor system 120 to acquire the sensor data 240. As part of controlling the sensors to acquire the sensor data 240, it is generally understood that the sensors acquire the sensor data 240 of a region associated with an occupant of the vehicle 100 with data acquired from different types of sensors generally overlapping in order to provide for a comprehensive sampling of the occupant. In general, the sensor data 240 need not be of the exact same bounded region of the occupant but should include a sufficient area of overlap such that distinct aspects of the occupant can be correlated. Thus, the control module 220, in one embodiment, controls the sensors to acquire the sensor data 240 of the occupant.

Additionally, the control module 220 can acquire the sensor data 240 from sensors of devices accessible by the vehicle 100. Further, the control module 220 can acquire the sensor data 240 from the cloud-computing environment 300, where the cloud-computing environment 300 stores the sensor data 240 acquired by devices of an occupant. In one approach, the control module 220 acquires the sensor data 240 from devices when the occupant is in an environment external to the vehicle 100 to inform the control module 220 of preferences of the occupant when the occupant is not in the vehicle 100. For example, the devices may acquire the sensor data 240 when the occupant is at home, in public, or in any other environment external to the vehicle 100.

Moreover, in further embodiments, the control module 220 controls the sensors to acquire the sensor data 240 at successive iterations or time steps. Thus, the immersion system 170, in one embodiment, iteratively executes the functions discussed at blocks 410-420 to acquire the sensor data 240 and provide information therefrom. Furthermore, the control module 220, in one embodiment, executes one or more of the noted functions in parallel for separate observations in order to maintain updated perceptions. Additionally, as previously noted, the control module 220, when acquiring data from multiple sensors, fuses the data together to form the sensor data 240 and to provide for improved determinations of reactions and behaviors of the occupant.

At 420, the control module 220 processes the sensor data 240 to determine a mental state of the occupant that is invoked by audio/visual/haptic/comfort stimuli. In one approach, the control module 220 determines the mental state by identifying physiological reactions of the occupant in response to the occupant experiencing audio/visual/haptic/comfort stimuli. The control module 220, in one approach, determines physiological reactions by identifying changes in heart rate, changes in skin arousal/conductivity, changes in facial expressions, changes in brain activity, and/or changes in eye/head/body movements of the occupant compared to baseline physiological measurements of the occupant stored in the occupant profile 250. The physiological reactions are, in one embodiment, indicative of a mental state (e.g., a happy state, a sad state, an angry state, an attentive state, a distracted state, a stressed state, etc.) of the occupant. The control module 220, in one embodiment, analyzes physiological reactions identified by different sensors to determine the overall mental state of the occupant when the occupant is exposed to audible/visual stimuli.

In one configuration, the physiological reaction is a change in heart rate of the occupant. The control module 220, in one approach, analyzes a heart rate of the user immediately before and after being exposed to audible/visual/haptic/comfort stimuli to determine a mental state that is invoked in the occupant when exposed to the audible/visual stimuli. When the heart rate of the occupant increases by a threshold amount (e.g., by 10 bpm or by 10%), the control module 220 determines that the occupant is happy, stressed, attentive, and/or panicked. In contrast, when the heart rate of the occupant decreases by a threshold amount (e.g., by 10 bpm or by 10%), the control module 220 determines that the occupant is relaxed or content. In one embodiment, the control module 220 analyzes the LF/HF ratio of HRV to determine the mental state of the occupant. For example, when the LF/HF ratio of HRV is low (e.g., 20-30), the control module 220 determines the occupant is calm/relaxed. On the other hand, when the LF/HF ratio of HRV is high (e.g., 30-40), the control module 220 determines that the occupant is stressed.

The physiological reaction may also include a change in skin arousal/skin conductivity. The control module 220, in one approach, analyzes the skin conductivity of the user immediately before and after being exposed to audible/visual/haptic/comfort stimuli to determine a mental state that is invoked in the occupant when exposed to the audible/visual/haptic/comfort stimuli. When the skin conductivity of the occupant increases by a threshold amount (e.g., an increase of 5%, 0.1 μS, etc.) in comparison to the baseline skin arousal/skin conductivity of the occupant, the control module 220 determines that the occupant is likely happy, attentive, stressed, or panicked. On the other hand, when the skin conductivity decreases by a threshold amount (e.g., a decrease of 5%, 0.1 μS, etc.), the control module 220 determines that the occupant is relaxed, comfortable, or content.

Additionally, the control module 220 analyzes physical movements and expressions to determine the mental state of the occupant. As previously discussed, the control module 220 may use a machine learning algorithm embedded within the control module 220, such as a convolutional neural network (CNN), to perform feature recognition over the sensor data 240 associated with the physical movements and facial expressions of the occupant. In one arrangement, the control module 220 analyzes eye/head/body movements of the occupant, as indicated by video/camera data, immediately before and after being exposed to audio/visual/haptic/comfort stimuli to determine the mental state of the occupant that is invoked when the occupant is exposed to the audible/visual/haptic/comfort stimuli. In one approach, the control module 220 determines the mental state by analyzing the speed of the movements. For example, if the occupant directs attention towards the stimuli quickly (e.g., within one second or less), then the control module 220 determines that the occupant enjoys the stimuli, is stressed by the stimuli, or panicked by the stimuli. If the response time is longer, then the control module 220 determines that the stimuli invoke mental states of relaxation or indifference.

Additionally, in one embodiment, the control module 220 analyzes the facial expressions of the occupant, as indicated by camera/video data, immediately before and after the occupant is exposed to audible/visual/haptic/comfort stimuli to determine the mental state of the occupant when exposed to the stimuli. For example, if the occupant is smiling, the control module 220 determines the occupant is happy. In contrast, if an occupant is frowning, has furrowed eyebrows, the control module 220 determines the occupant is upset, angry, and/or stressed.

In one approach, the control module 220 confirms a mental state of the occupant by controlling a device to prompt the occupant to answer questions and/or to provide feedback regarding the mental state of the occupant. For example, the device may ask the occupant, “Can you confirm that X audio/visual has made you feel stressed?” As another example, the device may prompt the occupant to rate or provide feedback about the determination of the mental state of the occupant. For example, the occupant may rate the mental state determination using thumbs up/thumbs down icons, emojis, stars, letter grades, etc.

In addition to identifying the mental state of the occupant based on physiological reactions of the occupant, the control module 220, in one approach determines the mental state of the occupant by analyzing manual inputs of the occupant generated via interactions with devices of the occupant. For example, an occupant may manually input that a visual/audio/haptic/comfort output made the occupant feel happy, sad, relaxed, stressed, etc. Further, in one approach, the control module 220 analyzes the interactions of the occupant with devices to determine the mental state of the occupant. The control module 220, in one configuration, determines that the occupant feels happy/relaxed in relation to audio/visual/haptic/comfort outputs the occupant chooses more than a threshold amount of times (e.g., more than five times per week, more than ten times per week, etc.). In contrast, the control module 220, in one embodiment, determines that the occupant feels stressed/upset by audio/visual outputs the occupant adjusts more than a threshold amount of times (e.g., more than three times per day, more than three times per week, etc.).

At 430, the control module 220 determines an occupant preference based on the physiological reactions, the inputs, and the interactions of the occupant, the occupant preference indicating proclivities of the occupant in relation to a surrounding environment. In one embodiment, the occupant preference includes an auditory preference, a visual preference, a haptic preference, and a comfort preference. Responsive to determining the occupant preferences, the control module 220 stores the occupant preferences in the occupant profile 250. In one embodiment, the control module 220 determines that the preferences of the occupant correspond to physiological reactions indicative of happy and relaxed mental states. For example, if responsive to seeing a visual/hearing an audible output/feeling a haptic output/experiencing a comfort output (e.g., feeling a change in temperature, smelling a new scent), the occupant experiences decreased heart rate/skin conductivity/LF/HF of HRV and smiles, the control module 220 determines that the visual/audible/haptic/comfort output is preferred by the occupant because the occupant is likely relaxed. On the other hand, if, responsive to seeing a visual/hearing an audible output/feeling haptics/experiencing a comfort output, the occupant experiences an increased heart rate/skin conductivity/LF/HF of HRV and has a look of distress on their face, the control module 220 determines that the visual/audible/haptic/comfort output is not preferred by the occupant because the occupant is likely stressed.

The control module 220, in one embodiment, determines that the occupant preference corresponds to the manual inputs that correspond to the occupant being happy/relaxed in relation to an audio/visual/haptic/comfort output. In one arrangement, the control module 220 determines that the occupant preference corresponds to the audio/visual/haptic/comfort outputs that were chosen via direct occupant interactions (i.e., the audio/visual outputs that are chosen enough (e.g., three days a week, ten days a week, etc.) for the control module 220 to determine that the audio/visual outputs invoke feelings of happiness/relaxation). In any case, the control module 220 determines that the audible/visual/haptic/comfort outputs that invoke happiness/relaxation are the occupant preferences.

In one approach, the control module 220 determines the occupant preferences according to differing cognitive states of the occupant when the physiological reactions are acquired. For example, if the occupant is experiencing a high cognitive load when a physiological reaction associated with the occupant being happy is acquired, the control module 220 determines that the positive physiological reaction corresponds to an occupant preference when the occupant is experiencing a high cognitive load. In one configuration, the control module 220 determines the cognitive load of the occupant based on the environment of the occupant. For example, if the occupant is in a stimulating/loud environment (e.g., in a public space) when exposed to the visual/audible stimuli, the control module 220 determines that the cognitive load of the occupant is high. On the other hand, if the occupant is in a non-stimulating, quiet environment, the control module 220 determines that the cognitive load of the occupant is low. Additionally, the control module 220 considers the behavior of the occupant in identifying the cognitive load of the environment. For example, if the occupant is multi-tasking, conversing with someone, or performing a mentally intensive task (e.g., driving, taking an assessment, etc.) when experiencing the audible/visual/haptic/comfort stimuli, then the control module 220 determines that the occupant has a high cognitive load. Conversely, if the occupant is in a neutral state (e.g., not talking with anyone, not performing any mentally exhaustive tasks) when exposed to audible/visual/haptic/comfort stimuli, the control module 220 determines that the occupant has a low cognitive load.

The control module 220 is, in one embodiment, further informed about the cognitive load of the occupant by analyzing the sensor data 240 that corresponds to brain activity of the occupant. As an example, if the brain activity of the occupant is relatively high when the occupant is exposed to audible/visual stimuli, then the control module 220 determines that the physiological reaction of the occupant is indicative of the preferences of the occupant when the occupant has a high cognitive load.

Moreover, the control module 220, in one arrangement, determines the cognitive load by prompting the occupant to confirm the cognitive load of the occupant while the sensor data 240 is acquired. For example, the control module 220 may control a device to ask the occupant, “Is it true that you are currently multi-tasking?” Additionally, the control module 220 may determine the cognitive load based on unprompted inputs of the occupant. As an example, an occupant may choose to convey to a device that they are currently experiencing a low cognitive load or high cognitive load.

In one arrangement, the occupant preference corresponds to vehicle settings that invoke focus/a quick response (e.g., responses within 0-2 seconds after being exposed to audible/visual stimuli) to safety critical information in the occupant. The control module 220, in one embodiment, determines the occupant preference by determining physiological reactions that indicate the quick reaction times of the occupant when experiencing different visual/audio/haptic/comfort stimuli. For example, in one approach, the occupant is a driver of the vehicle 100, and the physiological reaction is a response to a potential collision. The control module 220 may determine reaction times of the occupant by analyzing the sensor data 240 to identify how quickly the attention of the occupant is directed towards an experienced audio/visual/haptic output. Reaction times are, for example, the time it takes for an occupant to direct their gaze towards an audible/visual/haptic output or the time it takes for the occupant to have a physiological reaction (e.g., the time it takes for a heart rate, skin conductivity, or brain activity of the occupant to change).

With continued reference to 430, in addition to determining the occupant preference for an occupant of the vehicle 100, the control module 220, in one or more arrangements, determines a group preference for multiple occupants in the vehicle 100. In one approach, the group preference corresponds to the vehicle settings that invoke a collective physiological reaction indicative of mental states of the occupants. The collective physiological reaction is, in one arrangement, associated with the occupants of the vehicle 100 experiencing a relaxed and/or happy mental state. In one embodiment, the control module 220 determines the collective physiological reaction by analyzing the occupant profile 250 of each occupant to identify audio/visual/haptic/comfort settings that make each individual occupant happy and/or relaxed. In one approach, the control module 220 determines the group preference by identifying the audio/visual/haptic/comfort settings of the vehicle 100 that would be preferred by a majority of the occupants in the vehicle 100. For example, if three of the occupants prefer blue ambient lighting, volume output at 40 dB, a temperature of seventy degrees Fahrenheit (° F.), and one occupant prefers red ambient lighting, volume output at 30 dB, and a temperature of sixty-eight ° F., the control module 220 determines that the group preference corresponds to blue ambient lighting, volume output at 40 dB, and a temperature of seventy ° F.

In one embodiment, the control module 220 determines the group preference by determining a weighted average that corresponds to the audio/visual/haptic/comfort preferences of the group. The control module 220, in one approach, determines the weighted average by first determining the audio/visual/haptic/comfort preferences of each individual occupant. Subsequently, the control module 220 determines characteristics about the occupants, such as whether any of the occupants is a driver, the age demographic of the occupants, the current emotional state of the occupants, etc. Thereafter, the control module 220, in one arrangement, calculates the weighted average by giving the highest weight to the preferences of a driver of the vehicle 100, the next highest weight to the preferences of emotionally unstable/unhappy (e.g., stressed, angry, sad, etc.) occupants, and the next highest weight to vulnerable occupants (e.g., occupants in age demographics corresponding to elderly occupants, infant occupants, children, etc.). As an example, if a driver prefers red ambient lighting and rock music output at a volume of 40 dB while three other passenger prefers yellow ambient lighting and rock music output at a volume of 35 dB, the control module 220 determines that the group preference corresponds to orange ambient lighting with more red than yellow tones and rock music output at a volume of 38 dB. It should be understood that the weights can be adjusted according to the needs of the vehicle 100 and the occupants. For example, in one or more arrangements, a higher weight can be given to vulnerable occupant preferences or to emotionally unstable occupants. In this way, the immersion system 170 improves determining occupant preferences to determine vehicle settings that invoke physiological reactions in occupants of a vehicle.

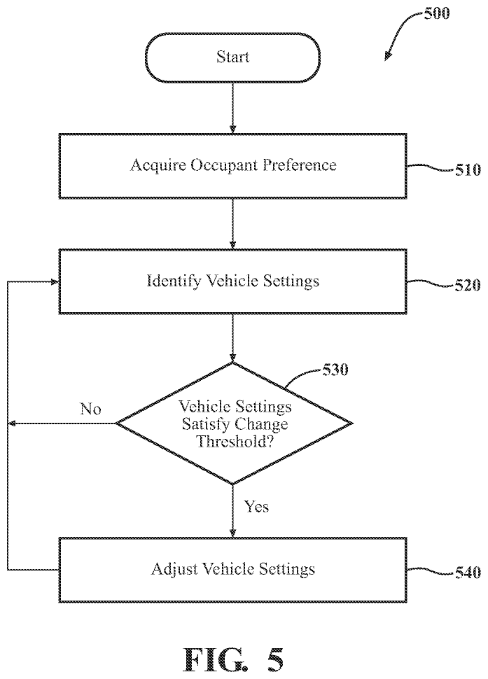

Additional aspects of providing a customized vehicle environment for occupants of a vehicle will be discussed in relation to FIG. 5. FIG. 5 illustrates a flowchart of a method 500 that is associated with improving an audio and/or visual environment of a vehicle according to occupant preferences. Method 500 will be discussed from the perspective of the immersion system 170 of FIGS. 1, and 2. While method 500 is discussed in combination with the immersion system 170, it should be appreciated that the method 500 is not limited to being implemented within the immersion system 170 but is instead one example of a system that may implement the method 500.

At 510, the control module 220 acquires an occupant preference from the occupant profile 250. As s previously discussed, the occupant profile 250 stores the audio/visual/haptic/comfort stimuli that invoke happy/relaxed mental states, reactions to safety critical information, and so on. In one approach, the control module 220 accesses the occupant profile 250 from the cloud-computing environment 300 or from the data store 230 of the vehicle 100.

At 520, the control module 220 identifies the vehicle settings of the vehicle 100, where the vehicle settings include auditory, visual, haptic, and comfort settings perceivable by an occupant. For example, the control module 220 may determine the volume/sound frequency of the auditory settings, the brightness, color, and flash pattern of the visual settings (e.g., ambient lights, multimedia displays, heads-up displays, lights, and so on), the vibration frequency and location of haptic settings, and the vehicle temperature, temperature of a heated seat/steering wheel, and scent of the comfort settings. In one embodiment, the control module 220 identifies the vehicle settings by acquiring data from systems of the vehicle 100 that output the auditory, visual, haptic, and comfort settings. As an example, the control module 220 may identify the volume and sound frequency of audio output from vehicle speakers, brightness, color, and flash pattern of visual outputs from vehicle lighting and display systems, the vibration frequency and location of haptic notifications from warning systems, and the temperature of the vehicle 100, the temperature of a heated seat/steering wheel, and scent outputs from vehicle comfort systems (e.g., an HVAC system).

At 530, the control module 220, in one approach, determines whether the vehicle settings satisfy a change threshold that is based, at least in part, on a difference between the vehicle settings and the occupant preference. If the difference between the vehicle settings and occupant preference satisfies the change threshold, the control module 220 determines that the current vehicle settings do not correlate to an acceptable difference between the vehicle settings and the occupant preference. The control module 220, in one embodiment, determines that the vehicle settings satisfy the change threshold when the vehicle settings cause a physiological reaction indicative of a stressed and/or distracted mental state. In one approach, the difference between the vehicle settings and occupant preference satisfies the change threshold when the vehicle settings cause a collective physiological reaction indicative of a stressed and/or distracted mental state of occupants in the vehicle 100.

Further, in one arrangement, the control module 220 determines that the difference between the vehicle settings and occupant preference satisfies the change threshold when the vehicle settings do not invoke a state of attentiveness/focus (i.e., a fast reaction time) in a driver of the vehicle 100. For example, if visual warnings of the vehicle 100 are preset to output red warning signs, a beep at 300 Hertz (Hz)/30 decibels (dB), and a haptic notification at 50 Hz but the occupant, on average, responds to blue warning signs, a chime at 440 Hz/50 dB five seconds, and a haptic notification at 60 Hz faster than the preset outputs, the control module 220 determines that the difference satisfies the change threshold.

In one arrangement, the control module 220 determines that a difference between the vehicle settings and occupant preference satisfies the change threshold when the difference is perceivable by the occupant. For example, the control module 220, in one approach determines that a difference between audio settings and occupant preferences satisfies the change threshold when the difference between the audio settings and occupant preferences differs by a perceivable amount, such as by more than five dBs, five Hz, or other predefined volumes/sound frequencies that are perceivable by the occupant. In one approach, the perceivable difference is preset by or learned for the occupant. Accordingly, if the difference between the audible settings and the occupant preferences is small (e.g., less than five dBs/five Hz), then the difference does not satisfy the change threshold as the difference represents a tolerable difference between the audible settings and occupant preferences. In one embodiment, the control module 220 analyzes individual aspects about the audible settings to determine which aspects of the audible settings satisfy the change threshold. For example, the control module 220 may determine that the difference between the noise level and the occupant preferences satisfies the change threshold while the difference between the sound frequency and the occupant preferences does not satisfy the change threshold.

In one embodiment, a difference between visual settings and occupant preference satisfies the change threshold when the visual settings are a different color, different brightness, and/or different flash pattern than what is preferred by the occupant. In one approach, the difference between the visual settings and occupant preference satisfy the change threshold when the visual settings output a flash pattern that differs by at least twenty Hz (or other change in frequency that is noticeable to the occupant) from the occupant preference, when the visual settings output a brightness that differs by at least three percent from the occupant preference, when the vehicle settings output a color that is a noticeably different shade than what is preferred by the occupant (e.g., red versus blue, green versus blue, etc.), when the visual settings result in dimming of a multi-media display that is not in accordance with preferences of the occupant (e.g., the dimness of the display is 5 lms dimmer than the preferred dimness of the occupant) and/or when the visuals differ by other perceivable threshold amounts. In one embodiment, the perceivable visual differences are preset by or learned for the occupant. As such, when the difference between the visual settings and the occupant preferences is slight (e.g., less than twenty Hz difference in flash patterns, less than three percent change in brightness, a minor deviation of color (e.g., a different shade of blue)), the difference does not satisfy the change threshold as the difference is likely unnoticeable to the occupant. In one embodiment, the control module 220 analyzes individual aspects about the visual settings to determine which aspects of the visual settings satisfy the change threshold. For example, the control module 220 may determine that the difference between the color and the occupant preferences satisfies the change threshold while the difference between the flash rate and the occupant preferences does not satisfy the change threshold.

In one approach, a difference between haptic settings and occupant preference satisfies the change threshold when haptic notifications are output at a different vibration frequency or from a different location within the vehicle 100 than what is preferred by the occupant. In one arrangement, the difference between the haptic settings and the occupant preference satisfy the change threshold when the vibration frequency differs by at least five Hz (or other change in frequency that is noticeable to the occupant) from the occupant preference or when the haptic notifications are output in a location that is not preferred by the occupant (e.g., the vehicle settings output haptic notifications in the steering wheel but the occupant prefers haptic notifications in the seat). In one embodiment, the control module 220 analyzes individual aspects about the haptic settings to determine which aspects of the haptic settings satisfy the change threshold.

In one approach, a difference between comfort settings and an occupant preference satisfies the change threshold when the temperature of the vehicle differs from what is preferred by the occupant, a seat/steering wheel temperature differs by what is preferred by the occupant, air is blown at a level that is not preferred by the occupant, and/or the vehicle outputs a scent that is not preferred by the occupant. In one configuration, the difference between the comfort settings and the occupant preference satisfies the change threshold when the vehicle temperature/seat temperature/steering wheel temperature differs by at least 1° F. (or other temperature difference noticeable by the occupant), when the air is blown at a speed that differs by at least 10 feet per minute (fpm), and/or when the scent output by the vehicle 100 is noticeably different (e.g., the scent output of the vehicle 100 corresponds to a floral scent but the occupant prefers a vanilla scent). In one embodiment, the control module 220 analyzes individual aspects about the comfort settings to determine which aspects of the comfort settings satisfy the change threshold.

Responsive to determining that the difference satisfies the change threshold, the control module 220 adjusts the vehicle settings as discussed at 540. Otherwise, when the difference between the vehicle settings and occupant preference do not satisfy the change threshold (i.e., when the vehicle settings are within a tolerable range of the occupant preference and/or the vehicle settings do not invoke physiological reactions indicative of a stressed/distracted mental state), the control module 220 continues to identify the vehicle settings as discussed at 520.

At 540, responsive to determining that vehicle settings satisfy the change threshold, the control module 220, in one embodiment, adjusts the vehicle settings according to the occupant preference. For example, the control module 220 adjusts the vehicle settings by adjusting the auditory, visual, haptic, and comfort settings of the vehicle 100 to match the auditory, visual, haptic, and comfort preferences of the occupant. In one arrangement, the control module 220 adjusts the vehicle settings according to the cognitive state of the occupant. Further, in one approach, where there is a group of occupants in the vehicle 100, the control module 220 adjusts the vehicle settings by adjusting the auditory, visual, haptic, and comfort settings of the vehicle 100 to match the group preference of the occupants.

In one approach, the control module 220 adjusts the visual settings according to the ambient lighting of the vehicle 100. For example, ambient lighting varies significantly while the vehicle 100 is driving (e.g., the vehicle 100 may experience bright sunlight, tree-or building-lined streets, tunnels, etc.). The pupil dilation of an occupant, in one or more arrangements, corresponds to the ambient lighting conditions. Accordingly, in one embodiment, the control module 220 analyzes the sensor data 240 (e.g., image data) associated with the pupil dilation of the occupant to determine the ambient lighting. For example, the pupil of a driver may be more constricted when the ambient lighting is bright. The control module 220, in one configuration, adjusts the visual settings based on the ambient lighting. As an example, when the ambient lighting is bright, the control module 220 increases the brightness of interior lighting of the vehicle 100 and/or adjusts the color output by the vehicle 100 to match the preferences of the occupant. On the other hand, when the ambient lighting is low, the control module 220 decreases the brightness of interior lighting of the vehicle 100 and/or adjusts the color output by the vehicle 100 to match the preferences of the occupant.

In one embodiment, the control module 220 adjusts the vehicle settings in a manner that prioritizes safety over occupant happiness/relaxation. For example, in one arrangement, the control module 220 adjusts the vehicle settings to match the preferences of the driver of the vehicle that correspond to fast reaction times in the driver, even if these preferences are not shared by passengers in the vehicle. As an example, when the vehicle 100 presents a safety warning about a potential collision, the control module 220 controls the vehicle settings to output the safety warning according to what would allow the driver to respond the fastest and/or that would allow the driver to achieve a heightened sense of focus.

Additionally, in one arrangement, rather than collectively adjusting the vehicle settings of the vehicle 100, where multiple occupants are present, the control module 220 adjusts settings in individual regions of the vehicle 100 to match the occupant preference of the occupants in individual regions of the vehicle. For example, if the driver prefers red ambient lighting, a passenger in the rear right seat of the vehicle 100 prefers blue ambient lighting, and the vehicle settings currently output green ambient lighting, the control module 220 adjusts the vehicle settings to output red ambient lighting in the region surrounding the driver and blue ambient lighting in the region surrounding the passenger. In this way, the immersion system 170 improves the safety and mood of vehicle occupants by customizing settings of the environment according to occupant preferences.

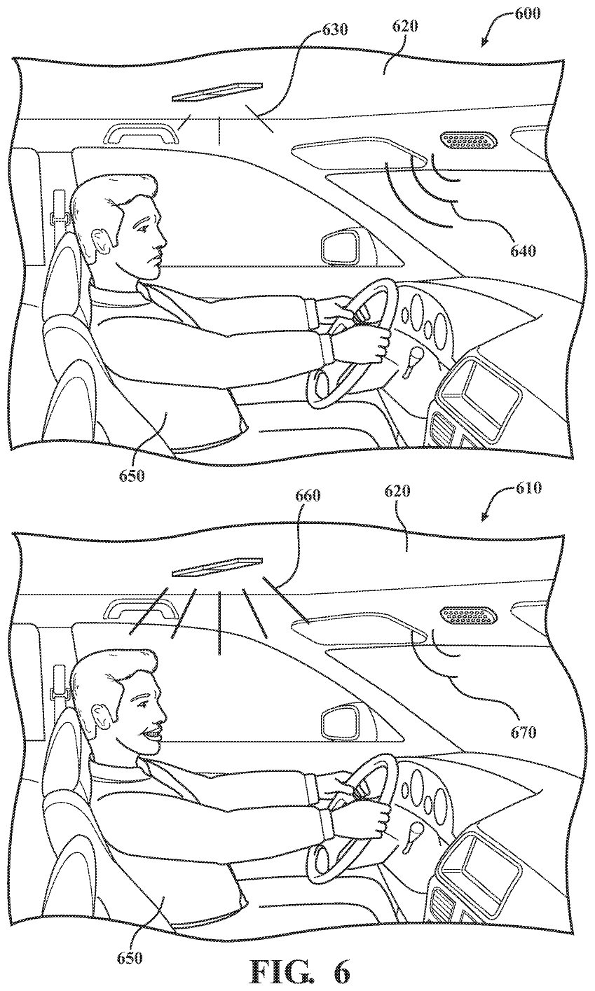

Discussion will now turn to FIG. 6 to further describe how the immersion system 170 can customize a vehicle environment according to occupant preferences. FIG. 6 will be discussed from the perspective of the immersion system 170 of FIGS. 1-3. FIG. 6 illustrates a sequence associated with improving a vehicle environment of an occupant. At timestep 600, a vehicle environment 620 is illustrated. The vehicle environment 620 includes a visual output 630 and an audio output 640. Although FIG. 6 illustrates the visual output 630 as being light emitted from lights along the roof of the vehicle environment 620 and the audio output as being audio emitted from speakers located in front of an occupant 650, it should be understood that, in one or more arrangements, the visual output 630 and audio output 640 may be emitted from light sources and speakers located anywhere within the vehicle environment 620. In any case, the visual output 630 and the audio output 640 result in a negative physiological reaction of the occupant 650. The negative physiological reaction is, for example, a physiological reaction indicative of a stressed or distracted mental state (e.g., elevated heart rate, elevated skin conductivity, changes in facial features, etc.).

At timestep 610, responsive to the control module 220 identifying that the difference between the visual output 630 and the audio output 640 and the preferences of the occupant 650 satisfy the change threshold, the control module 220 adjusts the environment settings of the vehicle according to preferences of the occupant 650. As illustrated, the control module 220 controls the environment settings to output a visual output 660, where the visual output 660 is a brighter light than the visual output 630 and where the visual output 660 is preferred by the occupant 650. Further, the control module 220 controls the environment settings to output an audio output 670, where the audio output 670 is a lower volume than the audio output 640 and where the audio output 670 is preferred by the occupant 650. As a result, the visual output 660 and the audio output 670 cause a positive physiological reaction in the occupant 650. A positive physiological reaction is, for example, a physiological reaction that corresponds to the occupant 650 having facial features associated with happiness (i.e., a happy, smiling face), the occupant 650 having a reduced heart rate, the occupant 650 having a reduced skin conductivity, and so on. In this way, the immersion system 170 improves a vehicle environment for an occupant.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in only a subset of possible modes.

In one or more embodiments, the vehicle 100 is an autonomous vehicle. As used herein, “autonomous vehicle” refers to a vehicle that is capable of operating in an autonomous mode (e.g., category 5, full automation). “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), and application specific integrated circuit (ASIC), a microprocessor, etc. The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, and hard drives. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time.

As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of each of the following: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system or a geolocation system.

The processor(s) 110, the immersion system 170, and/or the autonomous driving module(s) 160 can be operatively connected to communicate with the various vehicle systems 140 and/or individual components thereof. For example, returning to FIG. 1, the processor(s) 110 and/or the autonomous driving module(s) 160 can be in communication to send and/or receive information from the various vehicle systems 140 to control the movement of the vehicle 100. The processor(s) 110, the immersion system 170, and/or the autonomous driving module(s) 160 may control some or all of the vehicle systems 140 and, thus, may be partially or fully autonomous as defined by SAE 0 to 5.

The processor(s) 110, the immersion system 170, and/or the autonomous driving module(s) 160 can be operatively connected to communicate with the various vehicle systems 140 and/or individual components thereof. For example, returning to FIG. 1, the processor(s) 110, the immersion system 170, and/or the autonomous driving module(s) 160 can be in communication to send and/or receive information from the various vehicle systems 140 to control the movement. of the vehicle 100. The processor(s) 110, the immersion system 170, and/or the autonomous driving module(s) 160 may control some or all of the vehicle systems 140.

The processor(s) 110, the immersion system 170, and/or the autonomous driving module(s) 160 may be operable to control the navigation and maneuvering of the vehicle 100 by controlling one or more of the vehicle systems 140 and/or components thereof. For instance, when operating in an autonomous mode, the processor(s) 110, the immersion system 170, and/or the autonomous driving module(s) 160 can control the direction and/or speed of the vehicle 100. The processor(s) 110, the immersion system 170, and/or the autonomous driving module(s) 160 can cause the vehicle 100 to accelerate, decelerate and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be element or combination of elements operable to alter one or more of the vehicle systems 140 or components thereof to responsive to receiving signals or other inputs from the processor(s) 110 and/or the autonomous driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more autonomous driving modules 160. The autonomous driving module(s) 160 can be configured to receive data from the sensor system 120 and/or any other type of system capable of capturing information relating to the vehicle 100 and/or the external environment of the vehicle 100. In one or more arrangements, the autonomous driving module(s) 160 can use such data to generate one or more driving scene models. The autonomous driving module(s) 160 can determine position and velocity of the vehicle 100. The autonomous driving module(s) 160 can determine the location of obstacles, obstacles, or other environmental features including traffic signs, trees, shrubs, neighboring vehicles, pedestrians, etc.

The autonomous driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous driving module(s) 160 either independently or in combination with the immersion system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 240 as implemented by the control module 220. “Driving maneuver” means one or more actions that affect the movement of a vehicle. Examples of driving maneuvers include accelerating, decelerating, braking, turning, moving in a lateral direction of the vehicle 100, changing travel lanes, merging into a travel lane, and/or reversing, just to name a few possibilities. The autonomous driving module(s) 160 can be configured can be configured to implement determined driving maneuvers. The autonomous driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An immersion system comprising:
one or more processors;
a memory communicably coupled to the one or more processors and storing instructions that, when executed by the one or more processors, cause the one or more processors to:
acquire occupant data about an occupant in a vehicle;
process the occupant data to determine an occupant preference indicating proclivities of the occupant in relation to a surrounding environment; and
responsive to determining that vehicle settings satisfy a change threshold that is based, at least in part, on a difference between the vehicle settings and the occupant preference, adjust the vehicle settings according to the occupant preference.

2. The immersion system of claim 1, wherein the occupant preference includes an auditory preference, a visual preference, a haptic preference, and a comfort preference, and wherein the vehicle settings include an auditory setting, a visual setting, a haptic setting, and a comfort setting.

3. The immersion system of claim 1, wherein the instructions to acquire the occupant data include instructions to acquire a cognitive state of the occupant that defines a current ability of the occupant to focus,
wherein the instructions to determine the occupant preference include instructions to determine the occupant preference based, at least in part, on the cognitive state, and
wherein the instructions to adjust the vehicle settings include instructions to adjust the vehicle settings according to the cognitive state.

4. The immersion system of claim 1, wherein the instructions to determine the occupant preference include instructions to determine the vehicle settings that invoke a physiological reaction indicative of a mental state of the occupant, and
wherein the instructions to adjust the vehicle settings include instructions to adjust the vehicle settings to invoke the physiological reaction.

5. The immersion system of claim 1, wherein the instructions to determine the occupant preference include instructions to determine a group preference for occupants in the vehicle,
wherein the instructions to determine the group preference include instructions to determine the vehicle settings that invoke a collective physiological reaction indicative of mental states of the occupants, and
wherein the instructions to adjust the vehicle settings include instructions to adjust the vehicle settings to invoke the collective physiological reaction.

6. The immersion system of claim 1, wherein the instructions to determine that the vehicle settings satisfy the change threshold include instructions to determine that the vehicle settings cause a physiological reaction indicative of a mental state of the occupant, wherein the mental state is at least one of: a stressed state and a distracted state.

7. The immersion system of claim 1, wherein the instructions to acquire the occupant data include instructions to acquire sensor data about a physiological reaction indicative of a mental state of the occupant to at least one of an auditory output, a visual output, a haptic output, and a comfort output when the occupant is in an environment external to the vehicle to characterize the occupant preference when the occupant is not in the vehicle.

8. The immersion system of claim 1, wherein the instructions to adjust the vehicle settings include instructions to adjust the vehicle settings in a region of the vehicle that is associated with a seat that is occupied by the occupant.

9. A non-transitory computer-readable medium including instructions that when executed by one or more processors cause the one or more processors to:
acquire occupant data about an occupant in a vehicle;
process the occupant data to determine an occupant preference indicating proclivities of the occupant in relation to a surrounding environment; and
responsive to determining that vehicle settings satisfy a change threshold that is based, at least in part, on a difference between the vehicle settings and the occupant preference, adjust the vehicle settings according to the occupant preference.

10. The non-transitory computer-readable medium of claim 9, wherein the instructions to acquire the occupant data include instructions to acquire a cognitive state of the occupant that defines a current ability of the occupant to focus,
wherein the instructions to determine the occupant preference include instructions to determine the occupant preference based, at least in part, on the cognitive state, and
wherein the instructions to adjust the vehicle settings include instructions to adjust the vehicle settings according to the cognitive state.

11. The non-transitory computer-readable medium of claim 9, wherein the instructions to determine the occupant preference include instructions to determine the vehicle settings that invoke a physiological reaction indicative of a mental state of the occupant, and
wherein the instructions to adjust the vehicle settings include instructions to adjust the vehicle settings to invoke the physiological reaction.

12. The non-transitory computer-readable medium of claim 9, wherein the instructions to determine the occupant preference include instructions to determine a group preference for occupants in the vehicle,
wherein the instructions to determine the group preference include instructions to determine the vehicle settings that invoke a collective physiological reaction indicative of mental states of the occupants, and
wherein the instructions to adjust the vehicle settings include instructions to adjust the vehicle settings to invoke the collective physiological reaction.

13. The non-transitory computer-readable medium of claim 9, wherein the instructions to acquire the occupant data include instructions to acquire sensor data about a physiological reaction indicative of a mental state of the occupant to at least one of an auditory output, a visual output, a haptic output, and a comfort output when the occupant is in an environment external to the vehicle to characterize the occupant preference when the occupant is not in the vehicle.

14. A method, comprising:
acquiring occupant data about an occupant in a vehicle;
processing the occupant data to determine an occupant preference, indicating proclivities of the occupant in relation to a surrounding environment; and
in response to determining that vehicle settings satisfy a change threshold that is based, at least in part, on a difference between the vehicle settings and the occupant preference, adjusting the vehicle settings according to the occupant preference.

15. The method of claim 14, wherein the occupant preference includes an auditory preference, a visual preference, a haptic preference, and a comfort preference, and wherein the vehicle settings include an auditory setting, a visual setting, a haptic setting, and a comfort setting.

16. The method of claim 14, wherein acquiring the occupant data includes acquiring a cognitive state of the occupant that defines a current ability of the occupant to focus,
wherein determining the occupant preference includes determining the occupant preference based, at least in part, on the cognitive state, and
wherein adjusting the vehicle settings includes adjusting the vehicle settings according to the cognitive state.

17. The method of claim 14, wherein determining the occupant preference includes determining the vehicle settings that invoke a physiological reaction indicative of a mental state of the occupant, and
wherein adjusting the vehicle settings includes adjusting the vehicle settings to invoke the physiological reaction.

18. The method of claim 14, wherein determining the occupant preference includes determining a group preference for occupants in the vehicle,
wherein determining the group preference includes determining the vehicle settings that invoke a collective physiological reaction indicative of mental states of the occupants, and
wherein adjusting the vehicle settings includes adjusting the vehicle settings to invoke the collective physiological reaction.

19. The method of claim 14, wherein determining that the vehicle settings satisfy the change threshold includes determining that the vehicle settings cause a physiological reaction indicative of a mental state of the occupant, wherein the mental state is at least one of: a stressed state and a distracted state.

20. The method of claim 14, wherein acquiring the occupant data includes acquiring sensor data about a physiological reaction indicative of a mental state of the occupant to at least one of an auditory output, a visual output, a haptic output, and a comfort output when the occupant is in an environment external to the vehicle to characterize the occupant preference when the occupant is not in the vehicle.
